(19) United States
(12) Patent Application Publication
(10) Pub. No.: US 2026/0211991 A1
(43) Pub. Date: Jul. 23, 2026

(54) TEMPORAL KERNEL DEVICE UTILIZED FOR THRESHOLD COMPUTING, TEMPORAL KERNEL COMPUTING SYSTEM, AND OPERATING METHODS THEREOF

(71) Applicant: Seoul National University R&DB Foundation, Seoul (KR)

(72) Inventors: Cheol Seong HWANG, Seoul (KR); Sung Keun SHIM, Seoul (KR); Yoon Ho JANG, Seoul (KR)

(73) Assignee: Seoul National University R&DB Foundation, Seoul (KR)

(21) Appl. No.: 19/344,642

(22) Filed: Sep. 30, 2025

(30) Foreign Application Priority Data
Jan. 20, 2025 (KR) 10-2025-0007836

(51) Int. Cl. G06F 21/32; H10B 63/00

(52) U.S. Cl. CPC G06F 21/32; H10B 63/20

(57) ABSTRACT

Temporal kernel devices, temporal kernel computing systems including them, and methods of operating them are disclosed. The disclosed temporal kernel device may include at least one of temporal kernel cell structures, each of the temporal kernel cell structures, including: a first non-volatile memristor, a second non-volatile memristor connected in series with the first non-volatile memristor, and a capacitor disposed in parallel with the second non-volatile memristor, and the capacitor comprises a metal oxide semiconductor layer.

### CROSS-REFERENCES TO RELATED APPLICATION

The present application claims, under 35 U.S.C. § 119(a), the benefit of Korean Patent Application No. 10-2025-0007836, filed on Jan. 20, 2025 which is hereby incorporated by reference in its entirety.

### BACKGROUND

### 1. Field

The present disclosure relates to kernel-related devices and systems, and more particularly to temporal kernel devices utilized for critical computing, temporal kernel computing systems including them, and methods of operation thereof.

### 2. Description of the Related Art

In computer science, a kernel is a computer program at the heart of a computer's operating system, which is responsible for controlling the system as a whole and providing the various services necessary for applications to perform. In the emerging field of artificial intelligence, kernels may play a role in pre-processing the signals that feed into artificial neural networks. In particular, a temporal kernel is a hardware system that may process time-series data.

Conventional hardware for a temporal kernel is a reservoir computing device. Reservoir computing device includes a volatile memristor in a unit cell structure and is configured to process a time-varying input signal by exploiting the volatile nature of the memristor. However, conventional memristor-based reservoir computing systems face controllability issues due to the inherent fixed relaxation dynamics of a given material. In other words, the temporal kernel based on the volatile memristor is limited by the fact that the relaxation of the conductance state of the memristor is based on the material properties, so its rate might not be controlled and no other dynamics other than relaxation is realized. Therefore, it is difficult to control the temporal characteristics of the reservoir.

In addition, previously proposed memristive resistor-capacitor (RC) systems have inherent limitations in implementing higher-dimensional reservoirs due to their architecture, where one input signal is mapped to one memristor. To improve the diversity of reservoir states in physical reservoir computing systems, two approaches may be used: device-to-device variation (D2D variation) and virtual nodes. However, D2D variation is nearly impossible to control and has limitations in effectively enhancing reservoir richness. This problem arises because D2D fluctuation-based leveraging produces highly correlated dimensions, which increases the training parameters without significantly improving device performance. On the other hand, virtual node methods may perform well but suffer from sequential computation, which requires buffer memory to store temporal results.

### SUMMARY

The technical challenge of the present invention is to provide a temporal kernel device capable of achieving high dimensional data mapping and tunable dynamics.

Furthermore, the technical challenge of the present invention is to provide a temporal kernel device capable of identifying irregular event signals, thereby increasing the dimensionality of data mapping and performing efficient and accurate data processing.

Furthermore, a technical challenge of the present invention is to provide a temporal kernel computing system comprising the temporal kernel elements described above.

Further, a technical challenge of the present invention is to provide a method of operation of the temporal kernel device and temporal kernel computing system.

The problems that the present invention is intended to solve are not limited to those mentioned above, and other problems not mentioned will be understood by those skilled in the art from the following description.

According to one embodiment of the present invention, there is provided a temporal kernel device comprising at least one of temporal kernel cell structures, each of the temporal kernel cell structures including a first non-volatile memristor, a second non-volatile memristor connected in series with the first non-volatile memristor, and a capacitor disposed in parallel with the second non-volatile memristor, and the capacitor includes a metal oxide semiconductor layer.

The temporal kernel device may include the first non-volatile memristor and the second non-volatile memristor may include a first electrode layer, an oxide layer, and a second electrode layer.

The first electrode layer, the oxide layer, and the second electrode layer each may comprise a PHT structure including platinum (Pt), hafnium oxide (HfO₂), and titanium nitride (TiN), respectively. Further, the oxide layer may be equal to or less than 5 nm.

The capacitor may include a third electrode layer, the metal oxide semiconductor layer, and a fourth electrode layer, and the metal oxide semiconductor layer may include hafnium oxide (HfO₂).

The third electrode layer, the metal oxide semiconductor layer, and the fourth electrode layer each may include an NHS structure including nickel (Ni), hafnium oxide (HfO₂), and N-type silicon (n-Si), respectively. The metal oxide semiconductor layer may be equal to or less than 20 nm.

In addition, the threshold value may be determined by at least one of an input voltage (Vᵢₙₚᵤₜ) applied to the temporal kernel device and a pulse sequence of the input voltage value, a voltage (V_{M1}) of the first non-volatile memristor, a voltage (V_{M2}) of the second non-volatile memristor, and a flat band voltage value (V_{FB}) of the capacitor.

The threshold value may be determined based on a point in time when the discharging voltage (V_{M2}) of the second non-volatile memristor and the flat band voltage value (V_{FB}) of the capacitor are equal. The threshold value may be used to distinguish irregular event signals.

When an irregular event signal is input to the temporal kernel device, the voltage (V_{M1}) of the first memristor may represent a high peak signal for a subsequent signal input after a discharge of the capacitor has occurred.

A voltage of the first non-volatile memristor and the second non-volatile memristor may increase nonlinearly as the voltage applied by the analog pulse switching increases.

The capacitor may have a steep nonlinear capacitance-voltage curve with a flat band (V_{FB}) value in the positive region.

The thickness of the metal oxide semiconductor layer may be determined by the flat band (V_{FB}) and the capacitance density (fF/μm²) set in the positive region of the capacitor.

the first non-volatile memristor and the second non-volatile memristor are connected in series with one of the first electrode layer and the second electrode layer and one of the third electrode layer and the fourth electrode layer, and each electrode layer connected in series is different from the others.

According to embodiments of the present invention, by utilizing a 2M (memristor)-1MOSCAP temporal kernel cell structure including two nonvolatile memristors and a capacitor (MOSCAP) comprising a metal oxide semiconductor, a temporal kernel device capable of achieving high dimensional data mapping and tunable dynamics may be realized.

According to embodiments of the present invention, the PHT rectification characteristics and nonlinear current-voltage characteristics of the first memristor and the second memristor, and the nonlinear capacitance-voltage characteristics of the capacitor comprising a metal oxide semiconductor, enable the identification of irregular event signals, thereby providing a temporal kernel device that may increase the dimensionality of data mapping and improve the accuracy and efficiency of data processing.

In particular, according to embodiments of the present invention, by adjusting the size of the capacitor or adjusting the initial resistance value of the two non-volatile memristors, the thresholding time (tₜₕ) within the temporal kernel element may be easily adjusted to detect the event signal. Furthermore, the mapping signal may be varied by adjusting the pulse shape of the input signal, which may improve the utilization freedom of the temporal kernel element.

By applying the temporal kernel device according to the above embodiments, a temporal kernel computing system having excellent performance and applicable to various fields may be realized.

However, the effects of the present invention are not limited to the above effects, and may be extended in various ways without departing from the technical ideas and scope of the present invention.

### BRIEF DESCRIPTION OF THE DRAWINGS

FIG. 1 is an exemplary drawing illustrating a temporal kernel device according to one embodiment of the present invention.

FIG. 2 is a diagram illustrating a method of fabricating a temporal kernel device according to one embodiment of the present invention.

FIGS. 3A through 3C illustrate the structure, current-voltage (I-V) curves, capacitance-voltage (C-V) curves, and types of information stored in the memristors of a conventional temporal kernel device (FIGS. 3A and 3B) and a temporal kernel device (FIG. 3C) according to one embodiment of the present invention.

FIGS. 4A and 4B illustrate results depending on the type of input signal of a conventional temporal kernel device (1M1R1C or 2M1C) and a temporal kernel device (2M1MOS) according to one embodiment of the present invention, respectively.

FIG. 5 is a graph illustrating the principle of operation of a temporal kernel device according to one embodiment of the present invention.

FIG. 6 is a scanning electron microscope (SEM) image of a temporal kernel device according to one embodiment of the present invention, and FIGS. 7A and 7B are cross-sectional TEM images of a PHT memristor and NHS capacitor.

FIGS. 8A through 8D are graphs illustrating electrical characteristics of a temporal kernel device of the present invention.

FIG. 9A is a graph representing a single pulse voltage distribution when different voltages are input to the temporal kernel device of the present invention, and FIG. 9B is a graph representing a D2D change in threshold time with each input voltage.

FIGS. 10A through 10D are graphs depicting voltage distribution and conductance changes over an interval of successive input voltages input to a temporal kernel element according to one embodiment of the present invention.

FIGS. 11A through 11F are graphs representing measurement results of an electrocardiogram (ECG) measurement device using a temporal kernel element according to one embodiment of the present invention.

FIGS. 12A through 12E illustrate how speech data is analyzed using a temporal kernel device according to one embodiment of the present invention.

FIGS. 13A through 13C illustrate a method for authenticating a biometric authentication system comprising a temporal kernel element, according to one embodiment of the present invention.

### DETAILED DESCRIPTION

Embodiments of the present invention will now be described in detail with reference to the accompanying drawings.

The embodiments of the invention described below are provided for the purpose of more clearly illustrating the invention to those having ordinary skill in the art, and the scope of the invention is not intended to be limited by the following embodiments, which may be modified in various other ways.

The terms used in this specification are intended to describe specific embodiments and are not intended to limit the invention. Terms used herein in the singular form may include the plural form, unless the context clearly indicates otherwise. Furthermore, the terms “comprise” and/or “comprising” as used herein are intended to specify the presence of the mentioned shapes, steps, numbers, motions, absences, elements, and/or groups thereof, and are not intended to exclude the presence or addition of one or more other shapes, steps, numbers, motions, absences, elements, and/or groups thereof. Furthermore, as used herein, the term “connected” is intended to mean not only that certain elements are directly connected, but also that they are indirectly connected by the interposition of other elements between them.

Further, when the present disclosure refers to a member being located “on” another member, this includes not only when a member is abutting another member, but also when there is another member between the two members. As used herein, the term “and/or” includes any one of the enumerated items and any combination of one or more of them. In addition, the terms “about,” “substantially,” and the like as used in the disclosure are intended to mean at or near the range of numbers or degrees, taking into account inherent manufacturing and material tolerances, and to prevent infringers from taking unfair advantage of the disclosure where precise or absolute numbers are stated, which are provided for the purpose of illustration.

Embodiments of the present invention will now be described in detail with reference to the accompanying drawings. The sizes or thicknesses of the areas or parts shown in the accompanying drawings may be somewhat exaggerated for clarity and ease of description. Throughout the detailed description, like reference numerals designate like components.

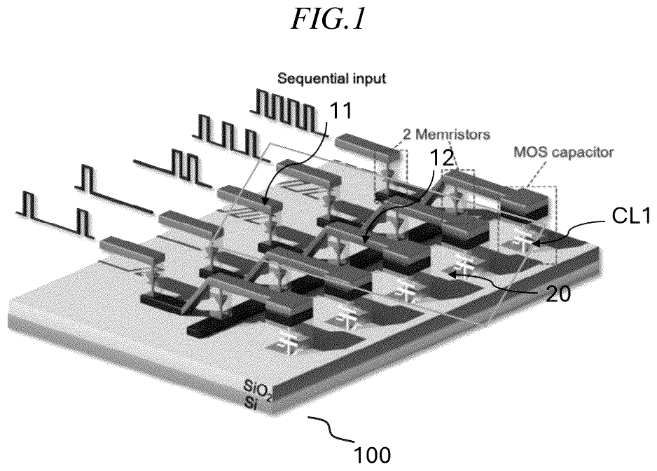

FIG. 1 is an exemplary drawing illustrating a temporal kernel device and a temporal kernel computing system including the temporal kernel device, according to one embodiment of the present invention. The temporal kernel device may be referred to as a hardware temporal kernel device.

Referring to FIG. 1, the temporal kernel device 100 according to an embodiment of the present invention may include one or more temporal kernel cell structures CL1. The temporal kernel cell structure CL1 may include a first nonvolatile memristor 11 and a second nonvolatile memristor 12 connected in series, and a capacitor 20, where the first nonvolatile memristor 11 and the second nonvolatile memristor 12 may be connected in parallel with each other, and the capacitor 20 may include a metal oxide semiconductor material. The temporal kernel cell structure CL1 may have a 2M1MOS configuration. Here, M denotes the non-volatile memristors 11, 12, and MOSCAP or MOS denotes the capacitor 20, more specifically, the capacitor 20 comprising a metal oxide semiconductor. The temporal kernel device 100 may be an integrated temporal kernel device having a 2M1MOS cell configuration.

Each of the first and second non-volatile memristors 11, 12 may include two electrodes (e.g., a bottom electrode and a top electrode) and a resistance change material layer (resistance change memory layer) disposed therebetween. For example, each of the first and second non-volatile memristors 11, 12 may have a Pt/HfO₂/TIN (PHT) structure, wherein TiN may correspond to the lower electrode (or upper electrode), Pt (platinum) may correspond to the upper electrode (or lower electrode), and HfO₂ may correspond to the resistance change material layer. However, this is only exemplary, and the specific structure and composition of the first and second nonvolatile memristors 11, 12 may be varied. Conventional non-volatile memristor structures and materials may be applied to the first and second non-volatile memristors 11, 12. The first and second non-volatile memristors 11, 12 may have the same stacking structure, but in some cases, they may have different stacking structures.

The capacitor 20 may include two electrodes (e.g., a bottom electrode and a top electrode) and a dielectric layer disposed therebetween. More specifically, the capacitor 20 may comprise a metal oxide semiconductor, for example, the capacitor 20 may have a Ni/HfO₂/n-Si (NHS) structure, wherein Ni, n-Si may correspond to the lower electrode and the upper electrode, and HfO₂ may correspond to the dielectric layer, respectively. The capacitor 20 having the metal oxide semiconductor material may have a nonlinear C-V curve. Due to such a nonlinear C-V curve, the temporal kernel device of the present invention may provide a thresholding effect. However, the specific structure and materials of construction of the capacitor 20 illustrated herein are exemplary only and may be varied in some cases. The structure and materials of conventional capacitors may be applied to capacitor 20.

Although the capacitor 20 is illustrated with a single capacitor element, in some cases, the capacitor 20 may include a plurality of capacitor elements. That is, the capacitor 20 may be understood to include a single capacitor element or to include a plurality of capacitor elements. When the capacitor 20 includes a plurality of capacitor elements, at least one of the plurality of capacitor elements may be selectively utilized.

According to one embodiment, in the temporal kernel cell structure CL1, the first non-volatile memristor 11 and the second non-volatile memristor 12 may be spaced apart in the same (or substantially the same) horizontal direction or may be spaced apart in the vertical axis, and the capacitor 20 may be spaced apart in the horizontal direction from the second non-volatile memristor 12. The capacitor 20 may be disposed at the same level (height) as the second non-volatile memristor 12, or at substantially the same level (height).

Also, the first nonvolatile memristor 11 and the second nonvolatile memristor 12 are fabricated simultaneously, wherein the first electrode layer of the first nonvolatile memristor 11 and the fourth electrode layer of the second nonvolatile memristor 12 are connected to the first electrode layer of the first nonvolatile memristor 11 and the second electrode layer of the second nonvolatile memristor 12 by a metal wiring process. Alternatively, the two memristors may be electrically connected in series through a metal wiring process of the second electrode layer of the first nonvolatile memristor 11 and the third electrode layer of the second nonvolatile memristor 12. In this case, the fabrication of the temporal kernel device 100 may be easy, and may be advantageous for improving space efficiency and integration. However, the arrangement relationship of the first non-volatile memristor 11 and the second non-volatile memristor 12 and the capacitor 20 in the temporal kernel cell structure CL1 is not limited to the foregoing, and may be varied in some cases.

The temporal kernel device 100 according to an embodiment of the present invention may have a temporal kernel cell structure CL1 having the above-mentioned 2M1MOS configuration, and in such a temporal kernel cell structure CL1, the information stored in the first and second nonvolatile memristors 11, 12 may be different under the influence of the capacitor 20. That is, the first and second nonvolatile memristors 11, 12 may store different information for the same input signal (a time series of input signals).

More specifically, a spike (voltage spike) signal may occur in the first non-volatile memristor 11 when a high signal enters the temporal kernel cell structure CL1 after the capacitor 20 is discharged by the low signal. Thus, it may be that the first non-volatile memristor 11 primarily reflects the number of transitions from low to high signals and related characteristics in an input signal in which low and high signals are randomly repeated. Thus, the first non-volatile memristor 11 may map the signal to distinguish pre- and post-threshold times.

On the other hand, the second non-volatile memristor 12 may reflect the number of high signals and their associated characteristics in the input signal, as it is primarily affected by the number of high signals input, in a different way than the first non-volatile memristor 11. Therefore, the second non-volatile memristor 12 may map signals proportional to the number of input signals. Thus, by adjusting the input voltage, the thresholding time (tₜₕ) may be adjusted within the same temporal kernel element.

The first non-volatile memristor 11 and the second non-volatile memristor 12 may exhibit a slow initial discharge and a distinct discharge behavior due to the rectification and nonlinear current-voltage (I-V) characteristics of the PHT memristor. These characteristics may prevent the temporal kernel element from responding to non-event signals. Thus, it may increase the dimensionality of data mapping and improve the accuracy and efficiency of data processing.

Furthermore, according to an embodiment of the present invention, the time constant may be easily adjusted, if necessary, by adjusting the size of the capacitor 20 or by adjusting the initial resistance values of the two non-volatile memristors 11, 12. Furthermore, the mapping signal may be varied by adjusting the pulse shape of the input signal, thereby increasing the freedom of utilization of the temporal kernel element.

The temporal kernel element 100 according to an embodiment of the present invention may be configured to process the time series input signal (input information) to store the information in the first and second non-volatile memristors 11, 12, and to input the information stored in the first and second non-volatile memristors 11, 12 into an artificial neural network (not shown). In other words, information stored in the first and second non-volatile memristors 11, 12 and then read out may be input to the artificial neural network. The information stored in the first and second non-volatile memristors 11, 12 may be input to the artificial neural network, for example, in the form of a memristor conductance vector (MCV), and the information (data) may be processed/recognized by the artificial neural network to determine what information was initially input to the temporal kernel element 100.

A temporal kernel computing system according to an embodiment of the present invention may include the temporal kernel element 100 described above and an artificial neural network connected to the temporal kernel element 100 and receiving input of information processed by the temporal kernel element 100. Specific configurations and principles of the artificial neural network may be the same or similar to those well known in the art.

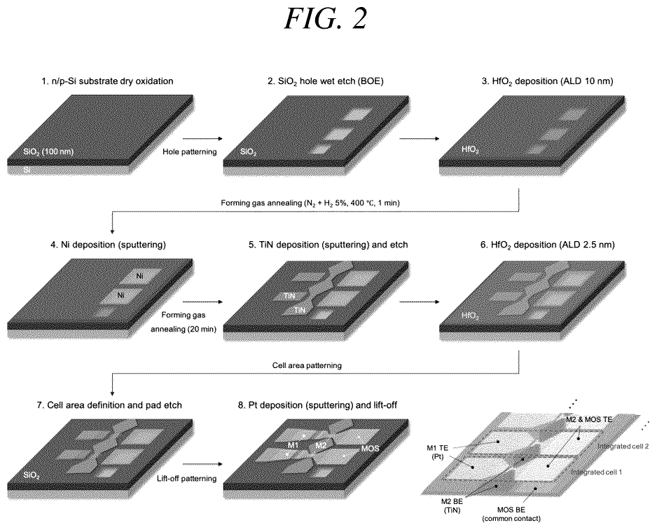

FIG. 2 is a diagram illustrating a fabrication method of a temporal kernel device according to one embodiment of the present invention. An exemplary brief description of the manufacturing method of the temporal kernel device is as follows.

According to one example, in fabricating a temporal kernel device, a capacitor (MOSCAP) may be fabricated, and a first non-volatile memristor and a second non-volatile memristor may be fabricated simultaneously. First, a SiO₂ layer with a thickness of about 100 nm on a Si substrate is thermally formed, and a plurality of holes in the portion to form the future capacitor may be formed by wet etching the SiO₂ layer with a buffered oxide etchant (BOE) solution. Subsequently, a layer of HfO₂ of about 10 nm may be deposited on the SiO₂ layer by a PEALD process at 280° C. using an atomic layer deposition method (ALD) of a tetrakis(ethylmethylamido) hafnium precursor and an O₃ reactant. Nitrogen is used as a carrier and purge gas, which may be formed by a gas annealing method (N₂+H₂ 5% 400° C., 1 min) on the HfO₂ layer, and the Ni layer may be formed by a sputtering method.

After stabilizing the capacitor by gas annealing the capacitor for 20 minutes, the TiN layer, which is the upper electrode, may be formed by sputtering in the form of lines and filled holes. Then, a 2.5 nm HfO₂ layer may be deposited on the TiN layer by atomic layer deposition. Cell regions may be defined on the HfO₂ layer and the cell regions may be patterned by pad etching, followed by deposition of Pt by sputtering and lift-off patterning. A time tunnel device system fabricated in this manner may include a first non-volatile memristor and a second non-volatile memristor connected in series, wherein the second non-volatile memristor may be connected in parallel with a capacitor.

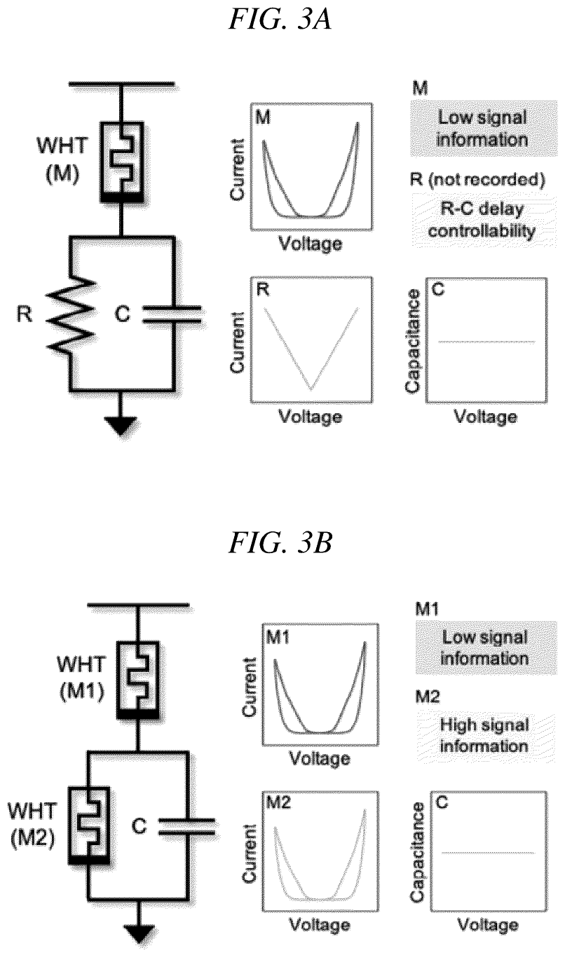

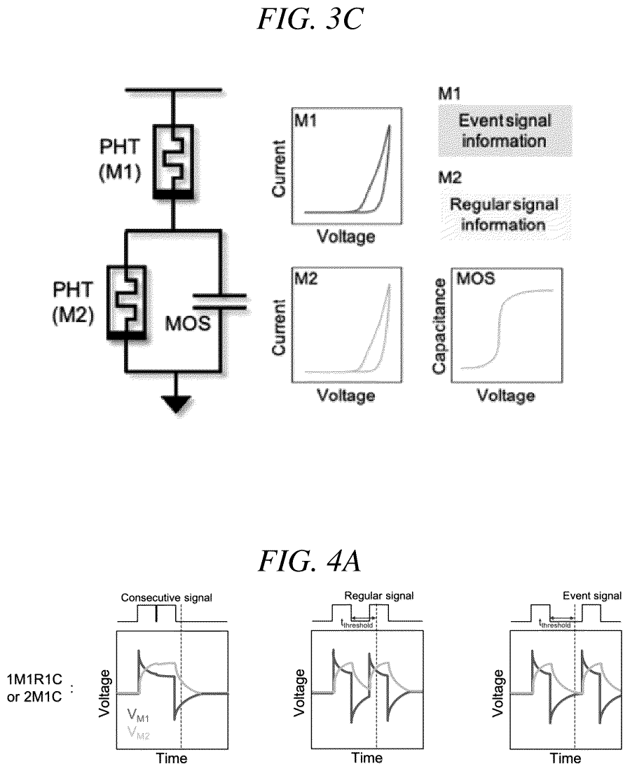

FIGS. 3A through 3C illustrate the structure, current-voltage (I-V) curves, capacitance-voltage (C-V) curves, and types of information stored in the memristors of a conventional temporal kernel device (FIGS. 3A and 3B) and a temporal kernel device (FIG. 3C) according to one embodiment of the present invention.

Referring to FIG. 3A, a conventional 1M1R1C kernel includes a non-current analog W/HfO₂/TIN (WHT) memristor (M) connected by a resistor (R) and a capacitor (C). The system may utilize an R-C delay that triggers a voltage spike across the memristor proportional to the degree of capacitor discharge. The 1M1R1C device does not produce voltage spikes under continuous high signals. On the other hand, a voltage spike will occur after a sufficient discharge time has elapsed, which is the only time the 1M1R1C kernel may detect a signal change. However, if a continuous high signal occurs, no information about it may be discerned.

To address these limitations, a 2M1C structure consisting of two memristors and one capacitor has been proposed. Referring to FIG. 3B, a conventional 2M1C kernel may be composed of two W/HfO₂/TIN (WHT) memristors and one conventional capacitor. Here, the two memristors M1 and M2 may show the ability to respond to continuous signals by collecting low and high signal information, respectively. However, referring to FIGS. 3A and 3B, both the 1M1R1C temporal kernel structure element and the 2M1C temporal kernel structure element may not be able to generate thresholds, which may make it difficult to accurately distinguish between normal signals and event signals. This is because the capacitors used in both kernels discharge rapidly initially and saturate quickly at the discharge rate, making it impossible to set a threshold.

Referring to FIG. 3C, a temporal kernel element according to one embodiment of the present invention may be thresholded by the rectification and nonlinear current-voltage (I-V) characteristics of the first and second nonvolatile memristors and the nonlinear capacitance-voltage (C-V) characteristics of a capacitor comprising a metal oxide semiconductor, Ni/HfO₂/n-Si (NHS).

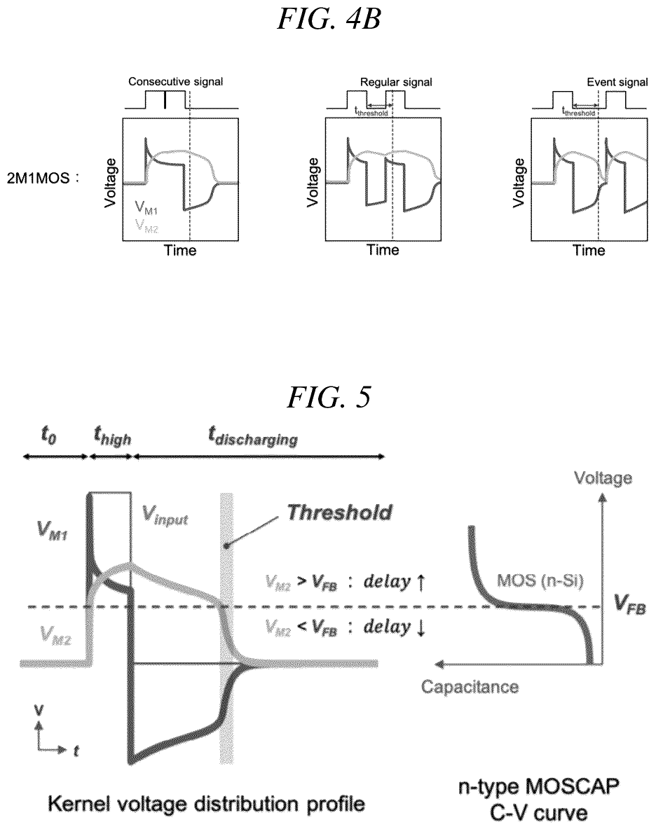

FIGS. 4a and 4b illustrate results depending on the type of input signal of a conventional temporal kernel device (1M1R1C or 2M1C) and a temporal kernel device (2M1MOS) according to one embodiment of the present invention, respectively.

Referring to FIG. 4A, a conventional temporal kernel device 1M1R1C or 2M1C might not distinguish between continuous, regular, and irregular signals because the capacitors all discharge rapidly early on, resulting in high voltage peaks for all.

Referring to FIG. 4B, the temporal kernel device (2M1MOS) of the present invention generates a voltage spike when the capacitor discharges. However, due to the rectification characteristics of the PHT memristor, the initial discharge exhibits a distinctly slower behavior, resulting in no high voltage peaks for continuous and regular signals. On the other hand, for irregular signals, which have a wider time interval than regular signals, the signal occurs after the initial discharge occurs, so the temporal kernel device of the present invention may generate a high voltage peak only when an irregular signal occurs. Therefore, the temporal kernel device (2M1MOS) of the present invention is capable of distinguishing an irregular signal from a regular signal.

FIG. 5 is a graph illustrating the operating principle of a temporal kernel device according to one embodiment of the present invention. Referring to FIG. 5, when a sufficiently high Vᵢₙₚᵤₜ pulse is applied to the device, a voltage (V_{M1}) on the first memristor (M1) and a voltage (V_{M2}) on the second memristor (M2) that is higher than V_{FB} of the capacitor are induced. After the Vᵢₙₚᵤₜ pulse ends (or when the voltage source is grounded), V_{M1} exhibits a negative value, while V_{M2} may slowly decay in the positive value region, maintaining the relationship V_{M1}+V_{M2}=0 due to the discharge of the MOS capacitor. Unlike conventional temporal kernel devices, when the voltage V_{M2} of the second memristor reaches the V_{FB} of the capacitor, the capacitance decreases sharply. Therefore, the voltages (V_{M1} and V_{M2}) of the first and second memristors suddenly approach the zero value, so that the threshold value of the kernel may be set.

A threshold-settable temporal kernel device may be implemented by integrating PHT memristors with NHS MOSCAP. In such a system, the threshold time may be adjusted by changing the device design or by changing the operating conditions of the kernel. The adjustable threshold feature enables the temporal kernel device of the present invention to enhance time series data analysis, making it more robust and applicable to real-world applications. Examples include electrocardiogram (ECG) analysis, voice recognition, and biometric authentication, thereby expanding the scope and impact of reservoir computing in real-world environments.

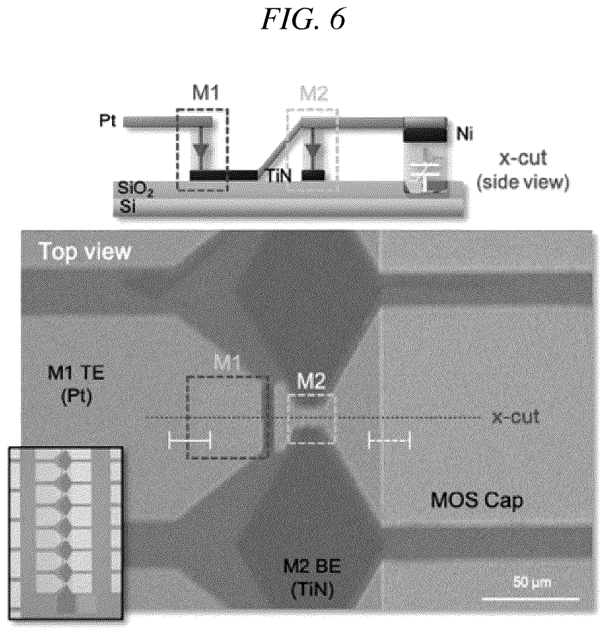

FIG. 6 is a scanning electron microscope (SEM) image of a temporal kernel device according to one embodiment of the present invention, and FIGS. 7a and 7b are cross-sectional TEM images of a PHT memristor and NHS capacitor.

Referring to FIG. 6, the temporal kernel elements may be fabricated in a parallel array that may be processed simultaneously within the array. After fabricating the NHS capacitor (MOSCAP) via a dry oxidation and hole wet etch process on a silicon wafer, the first and second PHT memristors (M1, M2) may be fabricated. During the simultaneous fabrication of the first and second PHT memristors, the two devices M1, M2 may be electrically connected in series by contacting the bottom TiN layer of the first PHT memristor and the top Pt layer of the second PHT memristor through a metal wiring process. Subsequently, the NHS capacitor (MOSCAP) may be connected in parallel with the second PHT memristor (M2).

Referring to FIGS. 7A and 7B, a PHT memristor of the present invention may include an HfO₂ layer deposited by plasma-enhanced atomic layer deposition, wherein the thickness of the HfO₂ layer may be 5 nm or less. Preferably, the thickness of the HfO₂ layer in the PHT memristor may be 2.5 nm or less. Furthermore, the NHS capacitor of the present invention may comprise an HfO₂ layer deposited by plasma-enhanced atomic layer deposition, and the thickness of the HfO₂ layer may be 20 nm or less. Preferably, the thickness of the HfO₂ layer of the NHS capacitor may be 10 nm or less.

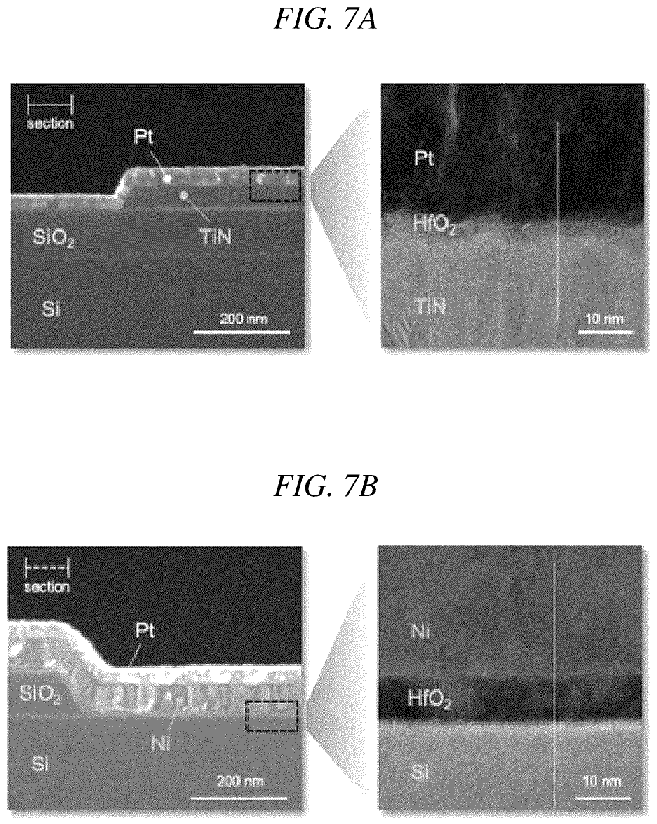

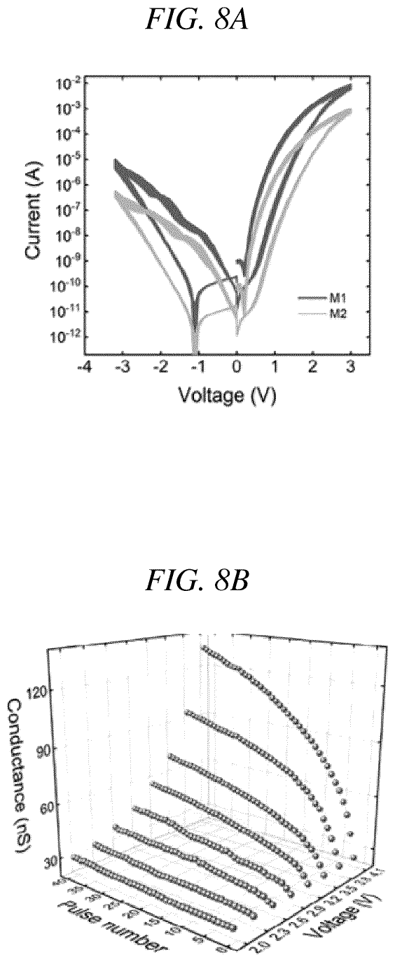

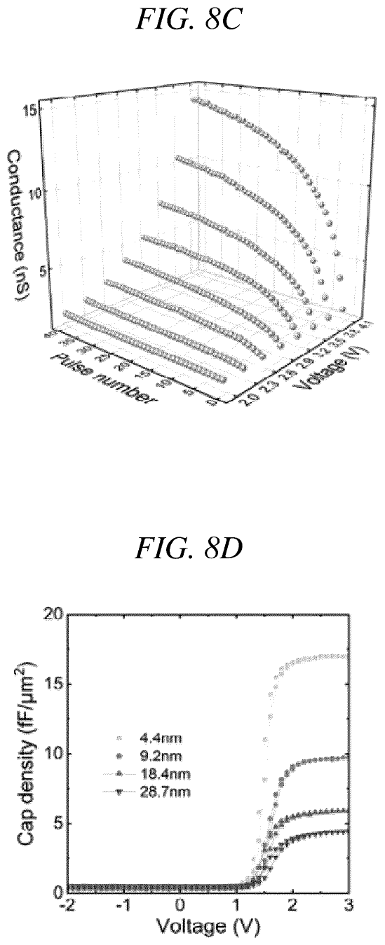

FIGS. 8A through 8D are graphs illustrating electrical characteristics of a temporal kernel device of the present invention.

Referring to FIG. 8A, the direct current (DC) I-V switching cycles of the first memristor and the second memristor exhibit a gradual switching characteristic with no electroforming phase, with voltage values within the range of −3.2 V to +3.0 V. The current levels of the first memristor and the second memristor may vary due to their different areas. Based on these area-dependent characteristics of the PHT memristors, the current ratio between the two memristors may be controlled while maintaining similar switching behavior. Subsequently, the area ratio of the two memristors of the temporal kernel device described with reference to FIGS. 8A through 8D may be 16:1. Further, the PHT memristor may exhibit volatile behavior at high conductance levels and non-volatile behavior at low to intermediate conductance levels. The present invention takes advantage of the low intermediate conductance range associated with the non-volatile behavior of these PHT memristors. The conductance range may be, for example, from 10 nS to 900 nS.

Referring to FIG. 8B and FIG. 8C, it may be seen that under various voltage conditions ranging from 2.0 V to 4.1 V with a pulse width of 20 μs, the first and second memristors exhibit analog pulse set switching that increases nonlinearly as the voltage of the first and second memristors increases, consistent with the I-V sweep curve. Thus, these results indicate that the PHT memristors have optimal characteristics for data mapping of input signals that vary in voltage distribution within the temporal kernel.

Referring to FIG. 8D, the C-V curves of NHS capacitors with HfO₂ layers of varying thicknesses from 4.4 nm to 28.7 nm are shown. To maximize the threshold effect of temporal kernel devices, MOSCAP capacitors should have V_{FB} in the positive region with a steep nonlinear C-V curve. Since V_{FB} is proportional to the work function of the metal, it may be seen that NHS capacitors using Ni (~5.15 eV) have a suitable V_{FB} of 1 to 2 V. It may be seen that V_{FB} shifts to more positive values as the HfO₂ layer thickness increases, but the capacitance density and nonlinearity slope decreases, so the capacitors utilized in the temporal kernel devices of the present invention may include capacitors of HfO₂ with thicknesses of 10 nm or less that achieve the desired V_{FB} (~1.8 V) and capacitance density (~10 fF/μm²) with a steep C-V slope.

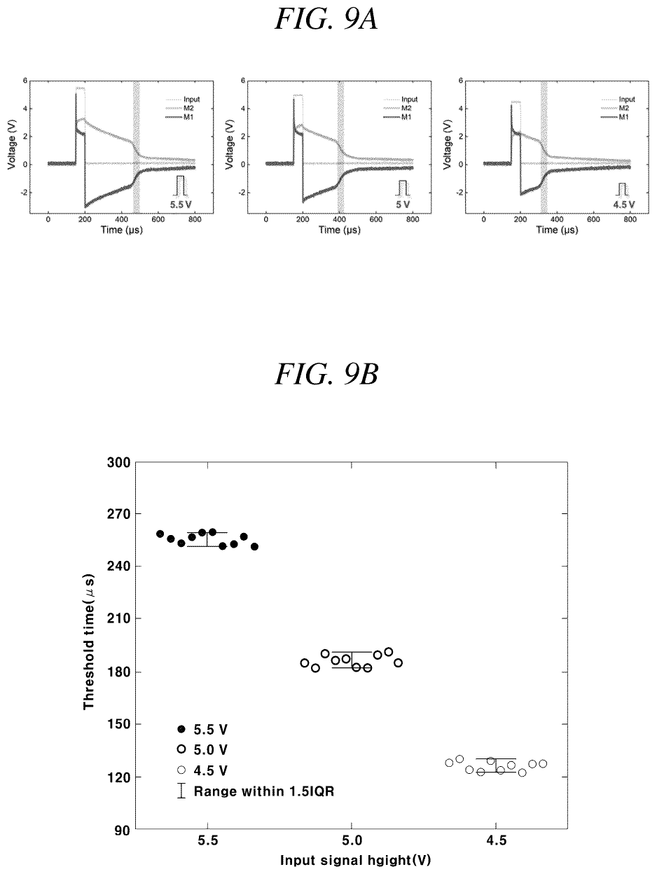

FIG. 9A is a graph representing a single pulse voltage distribution when different voltages are input to the temporal kernel device of the present invention, and FIG. 9B is a graph representing a D2D change in threshold time with each input voltage.

In the temporal kernel device of the present invention, the voltage distribution may have a decisive effect on the change in conductance of the first memristor and the second memristor. Furthermore, the voltages (V_{M1}, V_{M2}) of the first memristor and the second memristor may be distributed within the input voltage according to the equation Vᵢₙₚᵤₜ=V_{M1}+V_{M2}, and may be controlled by the operating current level of each memristor itself. Since kernel thresholding occurs when V_{M2} of the second memristor meets V_{FB} during discharge, the thresholding time (tₜₕ), which is the time from the end of Vᵢₙₚᵤₜ until thresholding occurs, may also be controlled by the Vᵢₙₚᵤₜ pulse sequence.

Referring to FIG. 9A, the voltage distribution across the first and second memristors of a single pulse with different input voltages of 5.5 V, 5 V, and 4.5 V, from left to right, may be seen. Since the amount of charge stored in the capacitor increases as the input voltage V input increases, the time to discharge and the time for V_{M2} of the second memristor to reach V_{FB} also increases, the thresholding time (tₜₕ) may increase as Vᵢₙₚᵤₜ increases. Referring to FIG. 9B, the D2D variation of the threshold time measured on the 10 times kernel devices for each input voltage is consistent across the voltage distribution of each device, showing stable operation.

As we have seen, since different current levels affect the voltage distribution, additional modulation of the thresholding time (tₜₕ) may be obtained by choosing different area ratios of the first and second memristors. Furthermore, for a given input voltage Vᵢₙₚᵤₜ, the voltage V_{M2} of the second memristor may be varied.

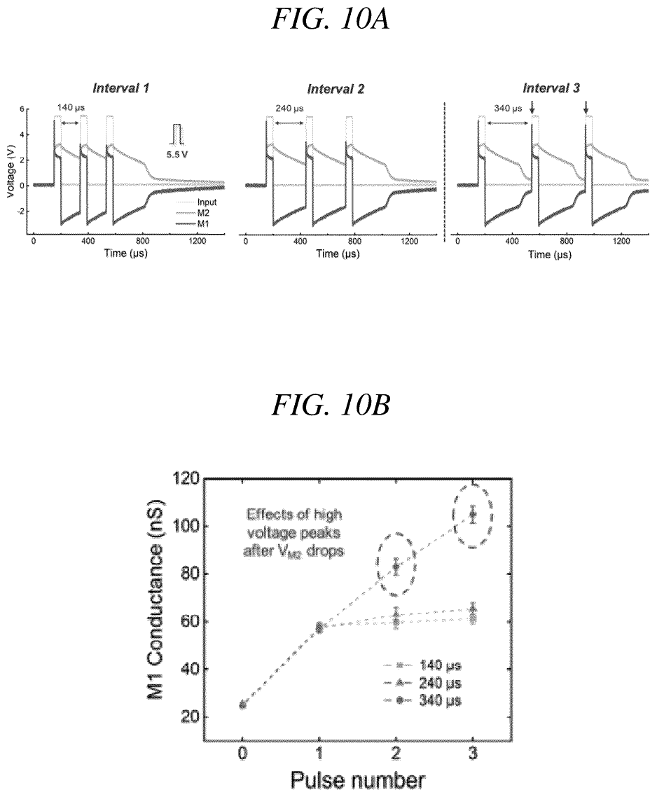

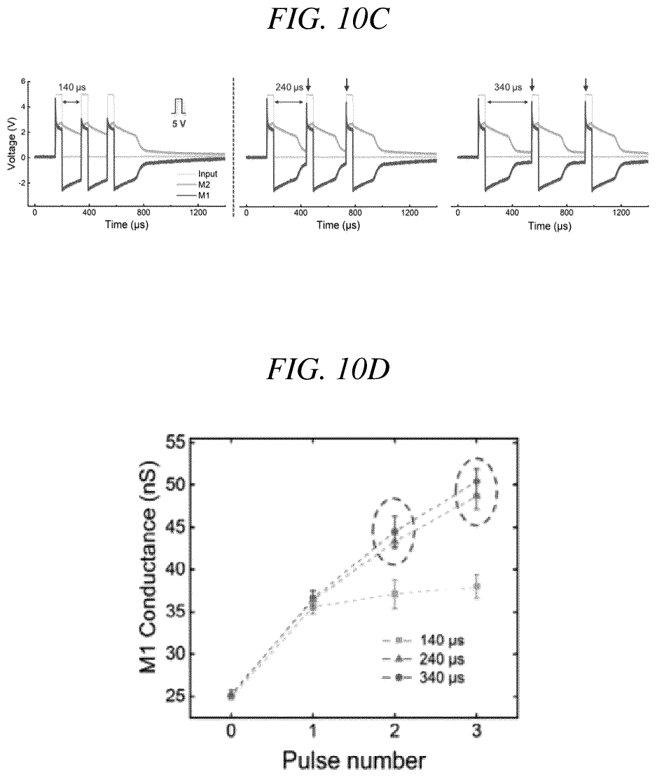

FIGS. 10A through 10D are graphs depicting voltage distribution and conductance changes over an interval of successive input voltages input to a temporal kernel element according to one embodiment of the present invention.

Referring to FIG. 10A, it may be seen that when successive input voltages Vᵢₙₚᵤₜ are received at intervals 140 μs, 240 μs, 340 μs from left to right, the voltage of the first memristor, V_{M1}, in each signal sequence always exhibits a high voltage peak at the beginning of the first pulse, but the response to the second and third pulses depends on the discharge state of the capacitor. For the 140 μs, 24 μs spaced pulses in FIG. 10A, no threshold occurred before the arrival of the second or third pulse. This is because the capacitor has not discharged to the point where V_{M2} of the second memristor reaches V_{FB}, resulting in a smaller peak in V_{M1} of the first memristor at the onset of the second and third signals.

However, if a signal is an input with an interval of 340 μs, as shown in the right graph of FIG. 10A, the interval of the input signal is longer than the thresholding time (tₜₕ), causing sufficient discharge of the capacitor and a high peak in the voltage of the first memristor. It may be seen that if a signal with an interval of 340 μs is an input, the capacitor discharges enough for V_{M2} to meet V_{FB} before the second pulse, so that a high peak in the voltage V_{M1} of the first memristor occurs after the discharge of V_{M2}. By checking the signal peak of this occurrence of the voltage V_{M1} of the first memristor, an abnormal signal may be detected.

Referring to FIG. 10C, it is observed that when the input voltage Vᵢₙₚᵤₜ is 5 V, the thresholding time (tₜₕ) is reduced to 190 μs, such that the high-voltage peak of the voltage M1 of the first memristor is generated at the beginning of the second and third pulse signals, in contrast to the results in FIG. 10A, even though the input signals are spaced 240 μs apart.

Referring to FIGS. 10B and 10D, the evolution profile of the conductance (G_{M1}) of the voltage M1 of the first memristor as a function of the number of input voltage pulses of 5.5 V and 5 V, respectively, may be seen. The conductance increases with the number of pulses when a high peak is continuously induced, for example, the conductance may be 340 μs for the input voltage pulses of 5.5 V in FIG. 10B and 240 μs and 340 μs for the input voltage pulses of 5 V in FIG. 10d. However, the conductance G_{M1} may remain relatively constant if no high peaks occur even if the signal is input multiple times. For example, it may be seen that the conductance remains constant for input voltages at 140 μs and 240 μs time intervals in FIG. 10B or at 140 μs time interval in FIG. 10D.

As such, by taking advantage of the nonlinearity of the conductance response to the applied voltage in FIGS. 8B and 8C, the relatively weak influence of the negative voltage region, and the optimization of the kernel for balanced voltage distribution, the voltage threshold setting method and the conductance update mechanism may be set. For example, various benefits may be achieved by adjusting the thresholding time (tₜₕ).

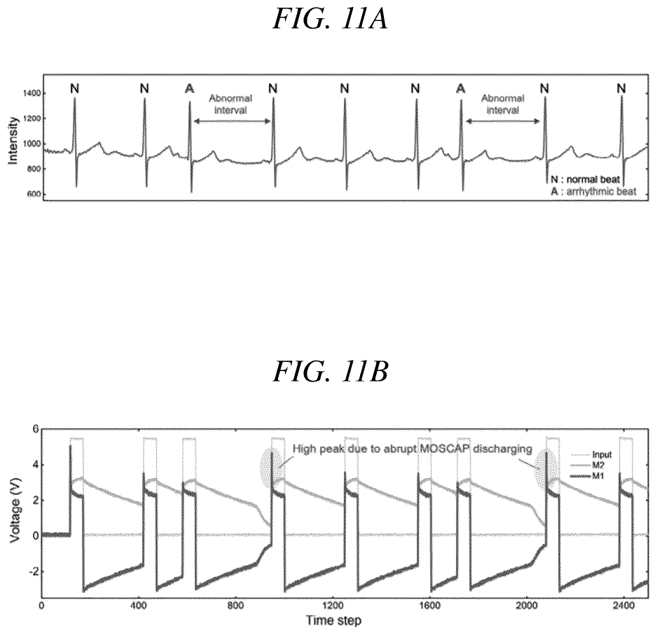

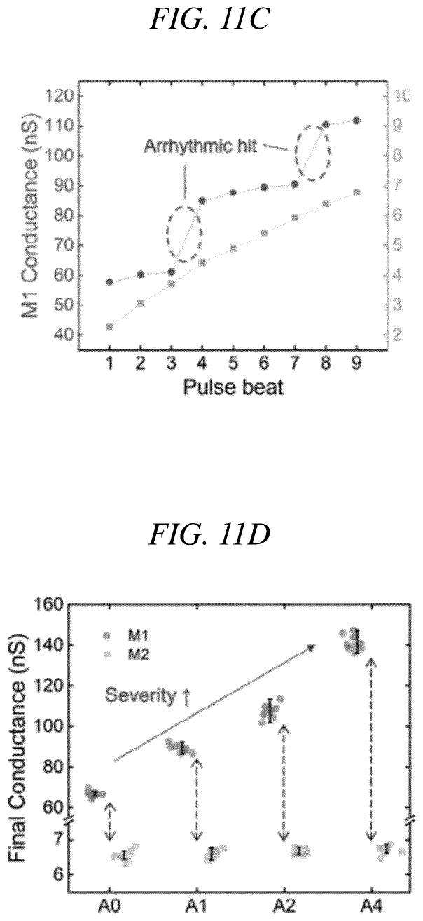

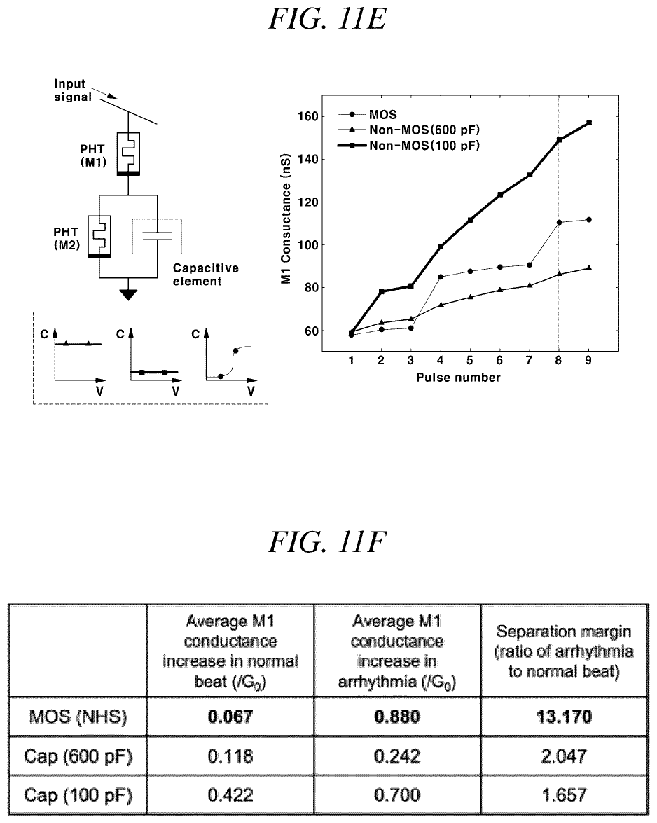

FIGS. 11A through 11F are graphs representing measurement results of an electrocardiogram (ECG) measurement device using a temporal kernel element according to one embodiment of the present invention.

Referring to FIGS. 11A and 11B, FIG. 11A is a graph of a measurement of a human heartbeat signal. Among the regular signals, the third and seventh heartbeat signals, labeled with the red letter A, produce irregular signal intervals, indicating an arrhythmia, which is a symptom of one of the heart diseases. Conversely, the regularly spaced heartbeat signals labeled with the black letter N are normal signals. If the thresholding time (tₜₕ) of the temporal kernel element is set between the normal heartbeat time and the arrhythmia interval, the temporal kernel element of the present invention may only respond to arrhythmia.

Referring to FIG. 11B in comparison to FIG. 11A, it may be seen that the voltage V_{M1} of the first memristor exhibits a strong peak in the subsequent signal, as the threshold is only triggered if an arrhythmia occurs after the heartbeat indicated by red A.

FIG. 11C shows the conductances (G_{M1}, G_{M2}) of the first memristor and the second memristor in response to the heartbeat of FIG. 11A. The conductance G_{M1} of the first memristor does not change until the heartbeat signals (the third and seventh signals) marked in red A, and then changes in the following signals, allowing the location of the arrhythmia to be specifically identified. The conductance of the second memristor, G_{M2} shows a linear tendency to increase as the number of heartbeats increases. This voltage-dependent signal mapping method of the first and second memristors results from the exponential conductance increase response of the PHT memristor to voltage magnitude. Therefore, the effect of high peaks in the voltage V_{M1} of the first memristor is more pronounced than in other parts of the voltage profile. Also, the voltage (V_{M2}) of the second memristor may have the largest effect in the highest V_{M2} region when a high signal is applied, rather than the effect of capacitor discharge.

FIG. 11D shows the conductances (G_{M1}, G_{M2}) of the final first and second memristors in 10 times kernel devices with 0, 1, 2, and 4 arrhythmias (A0, A1, A2, A4) of the heartbeat signal. Referring to FIG. 11D, it may be seen that the conductance G_{M1} of the first memristor increases as more arrhythmias occur (A0->A4). On the other hand, the conductance of the second memristor G_{M2} shows similar values in all cases. We may also measure the severity of the arrhythmia by referring to the beat length units.

FIG. 11E shows the evolution of the conductance of the first memristor (G_{M1}) (blue closed circle) measured using the temporal kernel device of the present invention for the heartbeat signal of FIG. 11A, and the conductance of the first memristor measured using a 2M1C device containing 600 pF (red open square) and 100 pF (green open triangle) capacitors. Even with a typical capacitive capacitor, longer time intervals induce more discharges, which may cause somewhat higher peaks with higher conductance growth rates compared to normal events (red open squares and green open triangles).

However, these high peaks require a long period of time, which may make it difficult to measure abnormal signals within the desired signal. For example, it is not possible to detect when an arrhythmia occurs in a heartbeat signal. However, the temporal kernel device of the present invention is able to accurately measure when these arrhythmia signals occur, i.e., after the third and seventh heartbeat signals (blue closed circles).

FIG. 11F is a more quantitative comparison of the isolation margins of the three times kernel devices of FIG. 11E. The initial conductance Go of the first memristor and the average conductance increase in normal and arrhythmic signals were measured in the temporal kernel devices including the comparative 600 pF capacitor and 100 pF capacitor and the MOS capacitor including the embodiment NHS, and the separation margin between the arrhythmic and normal cases was derived. Referring to FIG. 11F, it may be seen that the temporal kernel device (MOS (NHS)) of the present invention has a response in the arrhythmia case that is more than 13 times the separation of the normal case. This is more than 6 times higher than that of the comparative example. Therefore, the temporal kernel device of the present invention may effectively detect the target event while effectively eliminating unimportant signal noise.

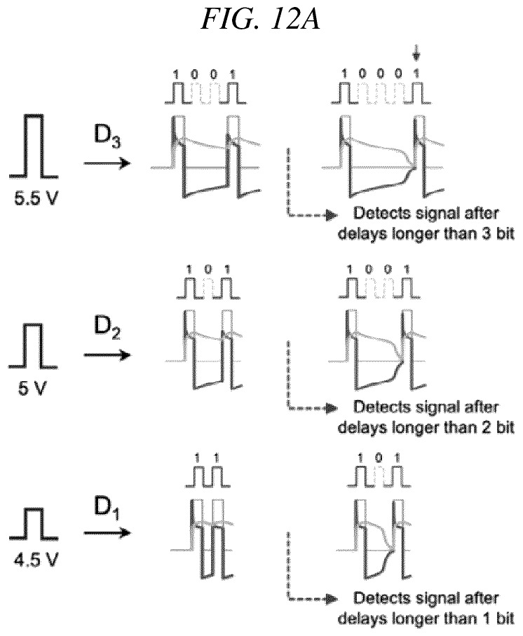

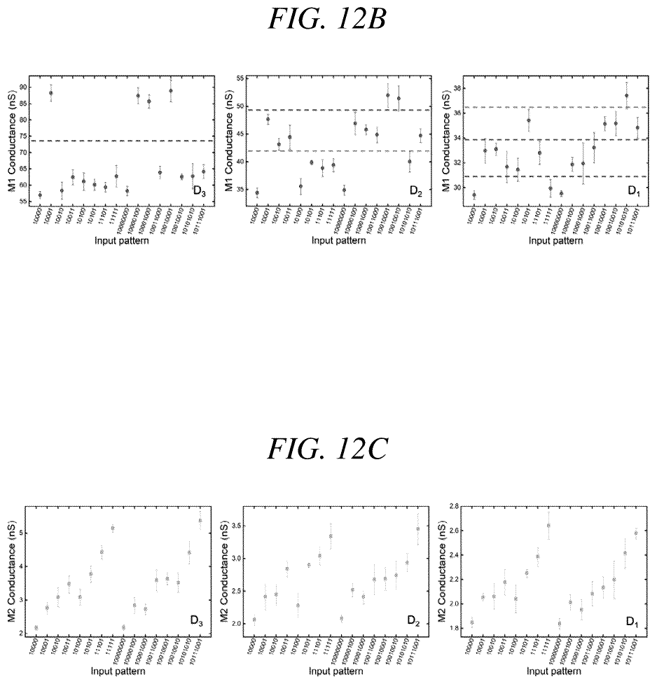

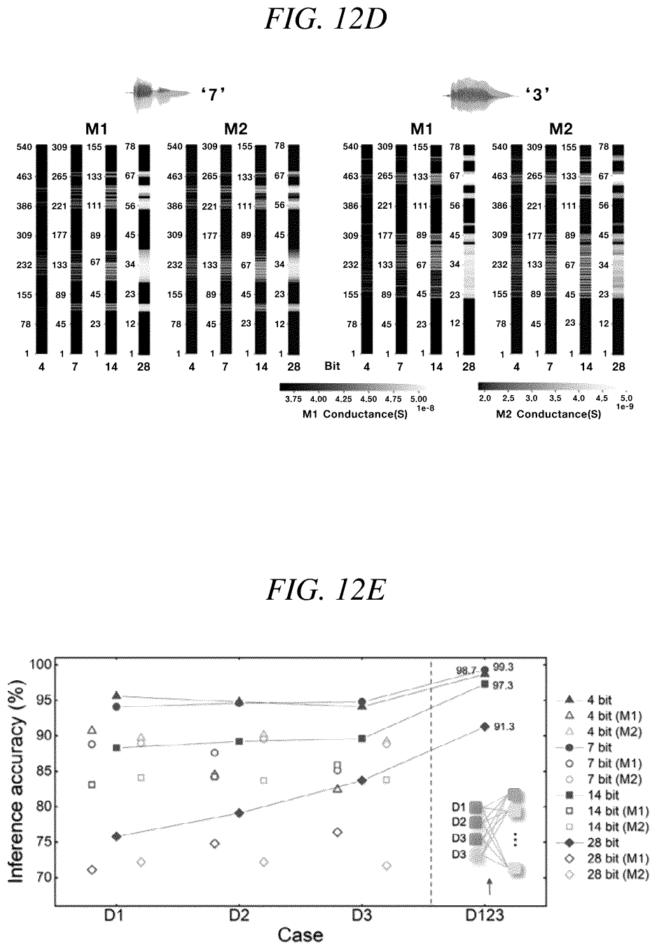

FIGS. 12A to 12E illustrate how speech data is analyzed using a temporal kernel device according to one embodiment of the present invention. The raw input data is a recorded sound waveform of isolated phonetic digits from “0” to “9” in English.

Referring to FIG. 12A, three thresholding cases (D1, D2, and D3) were prepared and tested to induce an increase in the conductance of the first memristor for signals after an interval longer than 3 bits, 2 bits, and 1 bit, respectively, using input voltages Vᵢₙₚᵤₜ of 5.5 V, 5.0 V, and 4.5 V. FIGS. 12B and 12C show the conductance (G_{M1}, G_{M2}) values of the first and second memristors measured in the three thresholding cases of D1, D2, and D3 for 16 different input signal patterns. Each input sequence to the kernel is prefixed with a reference signal ‘1’ for temporal separation. If there is no reference signal ‘1’, patterns such as ‘1100’ and ‘0011’ might not be distinguished, but if the reference signal is added, ‘1_1100’ and ‘1_0011’ may be distinguished.

Referring to FIG. 12B, it may be seen that the conductance G_{M1} of the first memristor maps to different values even for the same set of input signals when the kernel spacing of the temporal kernel elements is different. The red dashed lines indicate the boundaries, which may be grouped based on the number of occurrences of the high peak in each case. For example, for the D2 device, a signal with two occurrences of ‘0’ is accompanied by a strong response. Therefore, the patterns ‘10000’ and ‘10101010’ have the lowest level of G_{M1} because there is no ‘1’ after two consecutive ‘O's’. The ‘10010’ and ‘10010000’ patterns may induce an intermediate level of conductance because there is a single ‘1’ after two consecutive ‘0’s, and the ‘10011001’ pattern may induce the highest level of conductance of the first memristor because there are two consecutive ‘1’s after two consecutive ‘0’s. However, as shown in FIG. 12C, the conductance (G_{M2}) values of the second memristor in the three case devices D1 through D3 have similar trends with only slight differences. However, there is a general trend of increasing conductance values proportional to the higher number of signals in the input pattern. Therefore, different mapping trends may be exploited by setting the thresholding time (tₜₕ) with different input voltages in the same hardware kernel device, which may increase the degrees of freedom and dimensionality of the temporal kernel device.

FIG. 12D illustrates a threshold specified memristive conductance vector (TS-MCV) of the first and second memristors mapped to a temporal kernel element with a D2 threshold set for each bit of the digits ‘7’ and ‘3’ according to one embodiment of the present invention. Different truncated data may require different numbers of kernels. For example, if the raw data is truncated to 4 bits, there are seven 4-bit data in each frequency channel, and there are 78 frequency channels, so a total of 546 kernels may be required. However, if the raw data is truncated to 28 bits, only 78 kernels are required. These vectors, e.g., 546 vectors for 4 bits and 78 vectors for 28 bits, are input to the D1 to D3 temporal kernel elements of the present invention.

FIG. 12E illustrates the accuracy of each of the D1 through D3 thresholding cases with the above vectors input, and the accuracy of the temporal kernel element system when D1 through D3 are combined. Referring to FIG. 12E, it may be seen that the accuracy is higher when using a system of multiple thresholding cases by combining D1 to D3 than when using a single thresholding case (accuracy at D1, D2, and D3). Also for each cases, comparing the accuracy using only the first memristor (blue open symbols) and only the second memristor (yellow open symbols) with the case that includes both the first and second memristors, it may be seen that the accuracy is much higher for the cases that includes both the first and second memristors. Therefore, in all cases, the information extracted from the first and second memristors may complement each other, as the accuracy is significantly increased when the first and second memristors are used together.

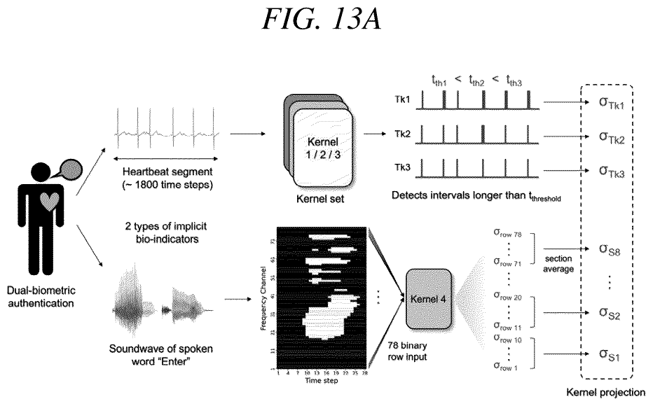

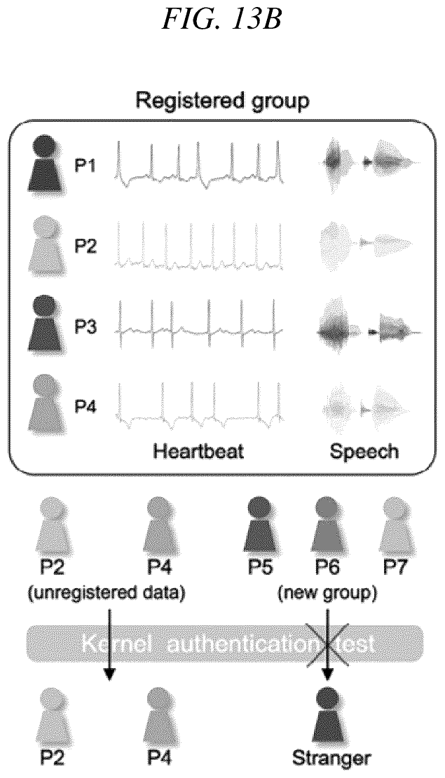

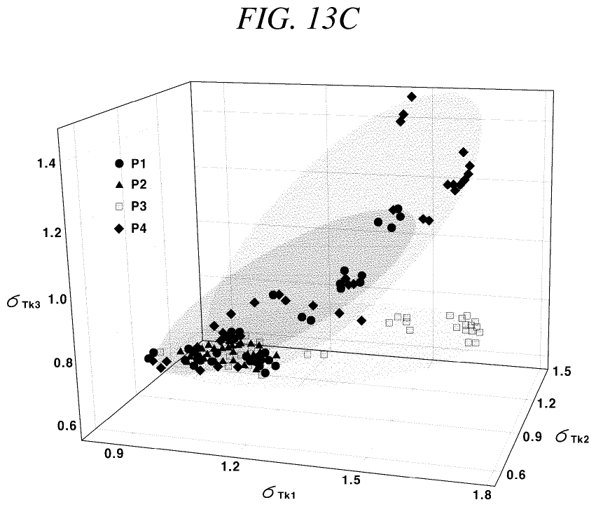

FIGS. 13A through 13C illustrate a method for authenticating a biometric authentication system comprising a temporal kernel element, according to one embodiment of the present invention.

A biometric authentication system including the temporal kernel element of the present invention may utilize a plurality of data as biometric indicators for biometric authentication. The biometric indicators may include heartbeat signals and voice signals. Since these biometric authentication systems focus on individual characteristics rather than distinguishing heartbeat abnormalities or categorizing different words, they require more specific and discriminative kernel functions. In addition, unlike clear physical indicators such as fingerprints or iris scans, heartbeat signals and voice signals are active, time-varying, multifaceted indicators that may provide a higher level of security for personal access.

Referring to FIG. 13A, an individual's heartbeat signal may be chopped into 5-second segments over 36 sequences over a 3-minute period. The segments may then be processed in three different temporal kernel elements Tk1, Tk2, and Tk3, each utilizing a different thresholding time. For example, when the heartbeat signal is processed, it may be observed that the Tk1 kernel element has four excessive signals, while the Tk2 kernel elements have one excessive signal each, and the Tk3 kernel element has no excessive signals. The sigma value (σ_{Tk1}, σ_{Tk2}, σ_{Tk3}) is introduced to compare the results of the three kernels. It represents the ratio of the increment of the conductance (G_{M1}, G_{M2}) of the first and second memristors, which increases as more signals exceed the thresholding time (tₜₕ) for a given sequence.

$$σ = \frac{Δ {G}_{M 1} / Δ {G}_{M 1 , initial}}{Δ {G}_{M 2} / Δ {G}_{M 2 , initial}} . \qquad [ Equation 1 ]$$

In this way, the response of a system of time-kernel devices set to a specific threshold may effectively detect and distinguish individual characteristics of a living organism, including the occurrence of rhythm abnormalities and the percentage of regular beats.

For speech data, a D3 temporal kernel element (Kernel 4) is used with the speech signal “enter” as a 28-bit unit signal sequence (σ_{row1}, . . . , σ_{row78}), and the sigma values of the final 8 sections (σ_{S1}, . . . , σ_{S8}) may be extracted by evaluating the sigma results of every 10 rows.

FIG. 13B is a scheme illustrating extraction and testing of heartbeat signals and speech data for each group of enrollees (P1 to P4) via the extraction method of FIG. 13A. As shown in FIG. 13B, the test is performed on enrolled subjects (P2, P4) and unenrolled subjects (P5, P6, P7) to verify that the extracted sigma values may accurately identify enrolled subjects and recognize unenrolled subjects.

FIG. 13C shows three sigma values (σ_{Tk1}, σ_{Tk2}, σ_{Tk3}) extracted for each sequence using three minutes of heartbeat signals per person for data enrollment of subjects P1 through P4. Referring to FIG. 13C, for P2, the heartbeat signal shows a fast steady state speed, which is low for all kernels because it rarely exceeds the thresholding time of Tk1. For P3, the overall speed is lower than P2, resulting in higher values for σ_{Tk1}, σ_{Tk2}, and σ_{Tk2}, but lower values for σ_{Tk3} because there are no severe abnormalities that exceed the thresholding time of Tk3. Thus, it indicates that adopting a multi-kernel thresholding system may detect arrhythmia and extract the overall pulse characteristics of an individual. Referring to FIG. 13D, for the speech data, the average of the sigma values (σ_{S1}, . . . , σ_{S8}) for each of the eight bins may be extracted using the four speech samples from P1 to P4 to identify the different channels that each person responds to.

As such, the temporal kernel device according to one embodiment of the present invention may implement a thresholding function, which may effectively process temporal data and detect irregular event signals. A 2M1MOS temporal kernel device comprising two memristors and one MOSCAP may utilize the nonlinearity of the C-V profile of the MOSCAP to adjust the threshold, thus implementing a nonlinear RC delay time to extract irregular event signals.

Furthermore, these features may be utilized for arrhythmia analysis of ECG data and may be used to obtain and utilize personal information by discriminating between vital signs. The use of MOSCAP's C-V nonlinearity in this memristive mapping scheme, and the use of a widely adjustable threshold time on a given hardware, are breakthrough features of the temporal kernel device of the present invention. Thus, the temporal kernel device of the present invention is a novel computing framework for memristive systems, which may also enhance the synergy of multiple devices through the integration of two or more different devices.

By applying the temporal kernel device according to the above embodiments, a temporal kernel computing system having excellent performance and applicable to various fields may be realized.

This description discloses preferred embodiments of the present invention, and although certain terms are used, they are used in a general sense only to facilitate the description and understanding of the invention and are not intended to limit the scope of the invention. In addition to the embodiments disclosed herein, other modifications based on the technical ideas of the present invention will be apparent to those of ordinary skill in the art to which the present invention belongs. One of ordinary skill in the art will recognize that the temporal kernel device and the temporal kernel computing system including the temporal kernel device and the method of operation thereof, according to the embodiments described with reference to FIGS. 1 through 13C, may be variously substituted, altered, and modified without departing from the technical ideas of the present invention. Therefore, the scope of the invention is not to be defined by the embodiments described, but by the technical ideas recited in the patent claims.

1. A temporal kernel device, comprising:
at least one of temporal kernel cell structures, and
each of the temporal kernel cell structures, comprising:
a first nonvolatile memristor;
a second nonvolatile memristor connected in series with the first nonvolatile memristor; and
a capacitor disposed in parallel with the second non-volatile memristor, and
wherein the capacitor comprises a metal oxide semiconductor layer.

2. The device of claim 1, wherein the first non-volatile memristor and the second non-volatile memristor comprise a first electrode layer, an oxide layer, and a second electrode layer.

3. The device of claim 2, wherein the first electrode layer, the oxide layer, and the second electrode layer each comprises a PHT structure including platinum (Pt), hafnium oxide (HfO₂), and titanium nitride (TiN), respectively.

4. The device of claim 2, wherein the oxide layer is equal to or less than 5 nm.

5. The device of claim 1, wherein the capacitor comprises a third electrode layer, the metal oxide semiconductor layer, and a fourth electrode layer.

6. The device of claim 1, wherein the metal oxide semiconductor layer comprises hafnium oxide (HfO₂).

7. The device of claim 5, wherein the third electrode layer, the metal oxide semiconductor layer, and the fourth electrode layer each comprises an NHS structure including nickel (Ni), hafnium oxide (HfO₂), and N-type silicon (n-Si), respectively.

8. The device of claim 7, wherein the metal oxide semiconductor layer is equal to or less than 20 nm.

9. The device of claim 1, wherein a threshold value is determined by at least one of an input voltage (Vᵢₙₚᵤₜ) applied to the temporal kernel device, a pulse sequence of the input voltage, a voltage (V_{M1}) of the first non-volatile memristor, a voltage (V_{M2}) of the second non-volatile memristor, and a flat band voltage value (V_{FB}) of the capacitor.

10. The device of claim 9, wherein the threshold value is determined based on a point in time at which a discharging voltage (V_{M2}) of the second non-volatile memristor becomes equal to a flat band voltage value (V_{FB}) of the capacitor.

11. The device of claim 9, wherein an irregular event signal is distinguished by using the threshold value.

12. The device of claim 1,
when an irregular event signal is input to the temporal kernel device,
wherein a voltage (V_{M1}) of the first memristor represents a high peak signal for a subsequent signal input after a discharge of the capacitor has occurred.

13. The device of claim 1, wherein a voltage of the first non-volatile memristor and the second non-volatile memristor increase nonlinearly as the voltage applied by the analog pulse switching increases.

14. The device of claim 1, wherein the capacitor has a steep nonlinear capacitance-voltage curve with a flat band (V_{FB}) value in the positive region.

15. The device of claim 1, wherein the thickness of the metal oxide semiconductor layer is determined by a flat band (V_{FB}) and a capacitance density (fF/μm²) set in a positive region of the capacitor.

16. The device of claim 1, wherein the first non-volatile memristor and the second non-volatile memristor are connected in series with one of the first electrode layer and the second electrode layer and one of the third electrode layer and the fourth electrode layer, and each electrode layer connected in series is different from the others.

17. A biosignal analysis system comprising at least one temporal kernel element of claim 1.

18. The biometric authentication system comprising at least one temporal kernel element of claim 1.
